(19) United States
(12) Patent Application Publication
(10) Pub. No.: US 2020/0190301 A1
(43) Pub. Date: Jun. 18, 2020

(54) ELASTOMER COMPOSITION, WATER-CROSSLINKABLE ELASTOMER COMPOSITION, AND METHOD FOR PRODUCING ELASTOMER COMPOSITION

(71) Applicant: RIKEN TECHNOS CORPORATION, Tokyo-to (JP)

(72) Inventors: Kouichi YAMAMOTO, Tokyo-to (JP); Rikuo SHIMIZU, Tokyo-to (JP)

(73) Assignee: RIKEN TECHNOS CORPORATION, Tokyo-to (JP)

(21) Appl. No.: 16/341,092

(22) PCT Filed: Oct. 12, 2017
(86) PCT No.: PCT/JP2017/037059

§ 371 Date: Feb. 11, 2020

(30) Foreign Application Priority Data
Oct. 12, 2016 (JP) 2016-200582

(51) Int. Cl. C08L 23/08; C08L 23/12; C08L 53/00; C08L 91/00; C08K 5/5419; C08K 5/5425; C08K 5/14; C08K 5/57; C08K 5/00; C08K 5/01; C08K 3/013; C08K 3/26

(52) U.S. Cl. CPC C08L 23/0815; C08L 2207/04; C08L 53/00; C08L 91/00; C08K 5/5419; C08K 5/5425; C08K 5/14; C08K 5/57; C08K 5/0025; C08K 5/01; C08K 3/013; C08K 3/26; C08L 2205/03; C08L 2203/30; C08L 2312/08; C08K 2003/265; C08L 23/12

(57) ABSTRACT

There is provided an elastomer composition which can be molded like a thermoplastic resin by using a conventional plastics processing equipment, and has a very small compression set like a vulcanized rubber. The elastomer composition comprises: 100 parts by mass of an ethylene/α-olefin copolymer (A); 10 to 150 parts by mass of a propylene-based resin (B); and 5 to 150 parts by mass of a non-aromatic softener for rubber (C); 0.03 to 1 parts by mass of an organic peroxide (D); 0.5 to 7 parts by mass of a silane coupling agent (E); 0 to 2 parts by mass of a crosslinking aid (F); and 0 to 100 parts by mass of an inorganic filler (G).

### FIELD OF THE INVENTION

The present invention relates to an elastomer composition. More particularly, the present invention relates to an elastomer composition which can be molded like a thermoplastic resin by using a conventional plastics processing equipment, and has a very small compression set like a vulcanized rubber.

### BACKGROUND ART

In recent years, an elastomer composition which is a soft material having rubber elasticity, and has the same moldability as a thermoplastic resin is used for automobile parts, home electrical appliance parts, electric wire coating, medical parts, footwear, miscellaneous goods and the like as a material substituting for vulcanized rubber. Further, in recent years, application of an elastomer composition to fields in which the elastomer composition is used in more severe environments is extensively attempted, and thus an elastomer composition having a very small compression set like a vulcanized rubber is required. To this problem, various elastomer compositions are proposed, but they do not achieve satisfactory levels.

### PRIOR ART DOCUMENT

### Patent Documents

### [Patent Document 1] JP 2002-322342 A

### [Patent Document 2] JP 2003-183450 A

### SUMMARY OF THE INVENTION

### Problems to be Solved by the Invention

An object of the present invention is to provide an elastomer composition which can be molded like a thermoplastic resin by using a conventional plastic processing equipment, and has a very small compression set like a vulcanized rubber.

### Means for Solving the Problems

The present inventor has made intensive studies, and as a result, has found that that the above object can be achieved by a specific elastomer composition.

That is, the present invention is an elastomer composition comprising:

100 parts by mass of an ethylene/α-olefin copolymer (A);

10 to 150 parts by mass of a propylene-based resin (B); and

5 to 150 parts by mass of a non-aromatic softener for rubber (C);

0.03 to 1 parts by mass of an organic peroxide (D);

0.5 to 7 parts by mass of a silane coupling agent (E);

0 to 2 parts by mass of a crosslinking aid (F); and

0 to 100 parts by mass of an inorganic filler (G);

wherein the each amount of (D) to (G) is based on the 100 parts by mass of the composition consisting of the ethylene/α-olefin copolymer (A), the propylene-based resin (B) and the non-aromatic softener for rubber (C).

The second invention is a water-crosslinkable elastomer composition further comprising 0.0001 to 0.3 parts by mass of a silanol condensation catalyst (H) based on 100 parts by mass of the elastomer composition according to the first invention.

The third invention is a molded article comprising the elastomer composition according to the first invention or the water-crosslinkable elastomer composition according to the second invention.

The fourth invention is a method for producing a molded article comprising:

(1) a step of dynamically heat-treating an elastomer composition comprising

100 parts by mass of an ethylene/α-olefin copolymer (A);

10 to 150 parts by mass of a propylene-based resin (B); and

5 to 150 parts by mass of a non-aromatic softener for rubber (C);

0.03 to 1 parts by mass of an organic peroxide (D);

0.5 to 7 parts by mass of a silane coupling agent (E);

0 to 2 parts by mass of a crosslinking aid (F); and

0 to 100 parts by mass of an inorganic filler (G);

wherein the each amount of (D) to (G) is based on the 100 parts by mass of the composition consisting of the ethylene/α-olefin copolymer (A), the propylene-based resin (B) and the non-aromatic softener for rubber (C);

(2) a step of blending 0.0001 to 0.3 parts by mass of a silanol condensation catalyst (H) to 100 parts by mass of the elastomer composition which is dynamically heat-treated in the step (1);
(3) a step of forming the elastomer composition to which (H) the silanol condensation catalyst is blended in the step (2) into a molded article by using a forming machine; and
(4) a step of treating the molded article formed in the step (3) with warm water.

### Effect of the Invention

The elastomer composition of the present invention can be molded like a thermoplastic resin by using a conventional plastic processing equipment, and has a very small compression set like a vulcanized rubber. Therefore, it can be suitably used for packing for automobile, packing for building materials and the like as a substitutive material for vulcanized rubber.

### DETAILED DESCRIPTION OF THE INVENTION

In the present specification, the term “resin” is used as a term including a resin mixture comprising two or more resins, and a resin composition comprising a component other than a resin. The term “or more” for a numerical range is used to mean a certain numerical value or a numerical value more than the certain numerical value. For example, 20% or more means 20%, or more than 20%. The term “or less” for a numerical range is used to mean a certain numerical value or a numerical value less than the certain numerical value. For example, 20% or less means 20%, or less than 20%. Further, the symbol “˜” for a numerical range is used to mean a certain numerical value, or a numerical value more than the certain numerical value and a numerical value less than another certain numerical value, or another certain numerical value. In this case, another certain numerical value is a numerical value larger than the certain numerical value. For example, 10-90% means 10%, or more than 10% and less than 90%, or 90%.

The elastomer composition of the present invention comprises an ethylene/α-olefin copolymer (A), a propylene-based resin (B), a non-aromatic softener for rubber (C), an organic peroxide (D) and a silane coupling agent (E). Preferably, the elastomer composition of the present invention further comprises a crosslinking aid (F). Preferably, the elastomer composition of the present invention further comprises an inorganic filler (G). In the case of subjecting the elastomer composition of the present invention to aftertreatment with warm water, a so-called water-crosslinking treatment, it is preferable to further comprise a silanol condensation catalyst (H). In the present specification, an elastomer composition comprising the silanol condensation catalyst (H) is sometimes referred to as a “water-crosslinkable elastomer composition.” Each component is described below.

### (A) Ethylene/α-Olefin Copolymer:

The component (A) is a copolymer mainly composed of ethylene and α-olefin. The component (A) imparts flexibility, and contributes to improvement of compression set (reduction of compression set).

Examples of the α-olefin include propylene, 1-butene, 1-pentene, 1-hexene, 1-octene, 1-decene, 1-dodecene, 2-methyl-1-propene, 2-methyl-1-butene, 3-methyl-1-butene, 2-ethyl-1-butene, 2,3-dimethyl-1-butene, 3-methyl-1-pentene, 4-methyl-1-pentene and the like. Among these, α-olefins having 3 to 10 carbon atoms are preferred. As the α-olefin, one of these or a mixture of two or more of these can be used.

In addition to ethylene and α-olefin, the component (A) may comprise a structural unit derived from a monomer copolymerizable therewith.

Examples of the copolymerizable monomer include nonconjugated diene-based monomer and the like. Examples of the non-conjugated diene-based monomer include 5-ethylidene-2-norbornene (ENB), 1,4-hexadiene, 5-methylene-2-norbornene (MNB), 1,6-octadiene, 5-methyl-1,4-hexadiene, 3,7-dimethyl-1,6-octadiene, 1,3-cyclopentadiene, 1,4-cyclohexadiene, tetrahydroindene, methyltetrahydroindene, dicyclopentadiene, 5-isopropylidene-2-norbornene, 5-vinyl-norbornene, dicyclooctadiene, methylene norbornene, ethylidene norbornene, norbornadiene, 1,2-butadiene, and 1,4-pentadiene and the like. As the copolymerizable monomer, one of these or a mixture of two or more of these can be used.

Specific examples of the component (A) include high density polyethylene, low density polyethylene, linear low density polyethylene, ethylene/propylene copolymer rubber, ethylene/propylene/nonconjugated diene copolymer rubber, ethylene/1-butene copolymer rubber, ethylene/1-butene/nonconjugated diene copolymer rubber, ethylene/1-octene copolymer rubber, ethylene/1-octene/nonconjugated diene copolymer rubber, ethylene/propylene/1-butene copolymer rubber, ethylene/propylene/1-octene copolymer rubber and the like. Among these, ethylene/1-octene copolymer rubber and ethylene/propylene/nonconjugated diene copolymer rubber (EPDM) are preferable from the viewpoint of flexibility. As the component (A), one of these or a mixture of two or more of these can be used.

The content of the structural unit derived from ethylene in the component (A) may preferably be 50 to 90% by mass, and more preferably 60 to 85% by mass, depending on the kind and molecular structure of α-olefin and the like (linear or not, having a long branch or not, and the like) which is copolymerized with ethylene.

The melt mass flow rate of the component (A) measured according to JIS K 7210: 1999, under condition of a temperature of 190° C. and a load of 21.18N is not particularly limited, but may preferably be 0.05 g/10 min or more, and more preferably 0.1 g/10 min or more from the viewpoint of moldability. On the other hand, from the view point of compression set, it may preferably be 10 g/min or less, and more preferably 1 g/10 min or less.

The Mooney viscosity M₁₊₄ of the component (A) measured according to ASTM D-1646, at a temperature of 125° C. is not particularly limited, but may preferably be 10 or more, and more preferably 20 or more from the viewpoint of compression set. On the other hand, from the viewpoint of moldability, it may preferably be 180 or less, and more preferably 150 or less.

The density of the component (A) measured according to JIS K 7112: 1999 may preferably be 850 to 900 Kg/m³, and more preferably 855 to 890 Kg/m³.

### (B) Propylene-Based Resin:

The component (B) is a propylene-based resin. The component (B) contributes to heat resistance and moldability.

The propylene-based resin is a polymer comprising propylene as a main monomer, and examples of the propylene-based resin include a propylene homopolymer, a random copolymer of propylene and a small amount of another α-olefin comonomer, and a block copolymer of propylene and α-olefin comonomer.

Examples of the α-olefin comonomer include ethylene, 1-butene, 2-methyl-1-propene, 1-pentene, 2-methyl-1-butene, 3-methyl-1-butene, 1-hexene, 2-Ethyl-1-butene, 2,3-dimethyl-1-butene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonene, 1-decene, 1-undecene, 1-dodecene and the like. Among these, ethylene, 1-butene, 1-pentene, 1-hexene and 1-octene are preferable, and ethylene, 1-butene and 1-hexene are more preferable. As the α-olefin comonomer, one of these or a mixture of two or more of these can be used.

Specific examples of the random copolymer of propylene and a small amount of another α-olefin comonomer include a propylene/ethylene random copolymer, a propylene/1-butene random copolymer, a propylene/1-hexene random copolymer, propylene/1-octene random copolymer, propylene/ethylene/1-butene random copolymer, propylene/ethylene/1-hexene random copolymer, propylene/ethylene/1-octene random copolymer and the like. Among these, propylene/ethylene random copolymer, propylene/1-butene random copolymer, propylene/1-hexene random copolymer, propylene/ethylene/1-butene random copolymer and propylene/ethylene/1-hexene random copolymer is preferable.

The block copolymer of propylene and α-olefin comonomer is a copolymer composed of a crystalline polypropylene component and a copolymer rubber component of propylene and α-olefin comonomer. The crystalline polypropylene component is composed of a propylene homopolymer or a random copolymer of propylene and a small amount of another α-olefin comonomer.

From the viewpoint of heat resistance, the component (B) is preferably a propylene homopolymer, or a block copolymer of propylene and α-olefin comonomer in which the crystalline polypropylene component is a propylene homopolymer.

As the component (B), one of these or a mixture of two or more of these can be used.

The peak top melting point of the peak of the component (B) appeared on the highest temperature side in the second melting curve (melting curve measured in the last temperature rising process) measured by using the Diamond DSC type differential scanning calorimeter of PerkinElmer Japan Co., Ltd. with a program of holding at 230° C. for 5 minutes, cooling to −10° C. at 10° C./min, holding at −10° C. for 5 minutes, and rising to 230° C. at 10° C./min may preferably be 150° C. or more, and more preferably 160° C. or more from the viewpoint of heat resistance. There is no particular upper limit on the peak top melting point, but because of a polypropylene-based resin, it may be about 167° C. at the highest.

The melt mass flow rate of the component (B) measured according to JIS K 7210: 1999, under condition of 230° C. and 21.18N may preferably be 0.1 to 1000 g/10 min, and more preferably 0.3 to 100 g/10 min from the view point of moldability and compression set.

The blending amount of the component (B) is typically 10 to 150 parts by mass, preferably 15 to 120 parts by mass, and more preferably 20 to 100 parts by mass based on 100 parts by mass of the component (A). From the viewpoint of flexibility and compression set, the blending amount of the component (B) is typically 150 parts by mass or less, preferably 120 parts by mass or less, and more preferably 100 parts by mass or less based on 100 parts by mass of the component (A). On the other hand, from the viewpoint of suppressing the generation of crosslinked aggregated substances, and improving mechanical properties, heat resistance and moldability, it is typically 10 parts by mass or more, preferably 15 parts by mass or more, and more preferably 20 parts by mass or more.

### (C) Non-Aromatic Softener for Rubber:

The component (C) is a non-aromatic softener for rubber. The component (C) functions to improve moldability and flexibility.

The non-aromatic softener for rubber is nonaromatic mineral oil (a hydrocarbon compound derived from petroleum and the like) or synthetic oil (synthetic hydrocarbon compound), and is typically liquid or in the form of gel or gum at room temperature. For the mineral oil, the nonaromatic means that the mineral oil is not classified as an aromatic type (the number of aromatic carbons is less than 30%) in the following categories. For the synthetic oil, it means that aromatic monomers are not used.

Mineral oil used as a softener for rubber is a mixture in which any one or more of a paraffin chain, a naphthene ring and an aromatic ring is combined, and those having a naphthene ring carbon number of 30 to 45% are called as a naphthenic type, those having an aromatic carbon number of 30% or more are called as an aromatic type, those not belonging to the naphthene type and aromatic type and in which the paraffin chain carbon number accounts for 50% or more of the total carbon number are called as a paraffin type, and these are distinguished from each other.

Examples of the component (C) include paraffinic mineral oils such as linear saturated hydrocarbons, branched saturated hydrocarbons, derivatives thereof and the like; naphthenic mineral oils; synthetic oils such as hydrogenated polyisobutylene, polyisobutylene, polybutene and the like; and the like. Commercially available examples of the component (C) include a isoparaffinic hydrocarbon oil “NA Solvent (trade name)” manufactured by NOF corporation, an n-paraffinic process oil “Diana Process Oil PW-90 (trade name)” and “Diana process oil PW-380 (trade name)” manufactured by Idemitsu Kosan Co., Ltd., a synthetic isoparaffinic hydrocarbon “IP-Solvent2835 (trade name)” manufactured by Idemitsu Kosan Co., Ltd., and an n-paraffinic process oil “Neothiosol (trade name)” manufactured by Sanko Chemical Industry Co., Ltd., and the like. Among these, from the viewpoint of compatibility, a paraffinic mineral oil is preferable, and a paraffinic mineral oil having a small number of aromatic carbons is more preferable. From the viewpoint of handling property, those which are liquid at room temperature are preferable. As the component (C), one or more of these can be used.

From the viewpoint of heat resistance and handling property, the dynamic viscosity of the component (C) measured according to JIS K2283: 2000, at 37.8° C. may preferably be 20 to 1000 cSt. From the viewpoint of handling property, the pour point measured according to JIS K2269: 1987 may preferably be −25 to −10° C. Further, from the viewpoint of safety, the flash point measured according to JIS K2265: 2007 (COC) may preferably be 170 to 300° C.

The blending amount of the component (C) is typically 5 to 150 parts by mass, preferably 10 to 140 parts by mass, and more preferably 20 to 130 parts by mass based on 100 parts by mass of the component (A). From the viewpoint of flexibility, the blending amount of the component (C) is typically 5 parts by mass or more, preferably 10 parts by mass or more, and more preferably 20 parts by mass or more based on 100 parts by mass of the component (A). On the other hand, from the viewpoint of suppressing the generation of bleed out, it is typically 150 parts by mass or less, preferably 140 parts by mass or less, and more preferably 130 parts by mass or less.

### (D) Organic Peroxide:

The component (D) is an organic peroxide. The component (D) functions to generate radicals during melt-kneading and to crosslink the component (A) by reacting the radicals in a chain reaction to achieve good (very small) compression set.

Examples of the component (D) include dicumyl peroxide, di-t-butyl peroxide, 2,5-dimethyl-2,5-di-(t-butylperoxy)hexane, 2,5-dimethyl-2,5-di(t-butylperoxy)hexine-3, 1,3-bis(t-butylperoxyisopropyl)benzene, 1,1-bis(t-butylperoxy)-3,3,5-trimethylcyclohexane, n-butyl-4,4-bis(t-butylperoxy) valerate, benzoyl peroxide, p-chlorobenzoyl peroxide, 2,4-dichlorobenzoyl peroxide, t-butyl peroxybenzoate, t-butyl peroxy isopropyl carbonate, diacetyl peroxide, lauroyl peroxide, t-butyl cumyl peroxide and the like. As the component (D), one or more of these can be used.

Among these, as the component (D), 2,5-dimethyl-2,5-di-(t-butylperoxy) hexane and dicumyl peroxide are preferable from the viewpoint of odor property, staining property and scorch safety.

Examples of commercially available product of the component (D) include “Perhexa 25B (trade name),” “Percumyl D (trade name)” manufactured by of NOF Corporation, and the like.

The blending amount of the component (D) is typically 0.03 to 1 parts by mass, preferably 0.05 to 0.8 parts by mass, and more preferably 0.1 to 0.6 parts by mass based on 100 parts by mass of a total of the components (A) to (C) (in other words, the composition consisting of the components (A) to (C)). From the viewpoint of sufficiently crosslinking to reduce the compression set, the blending amount of the component (D) is typically 0.03 parts by mass or more, preferably 0.05 parts by mass or more, and more preferably 0.1 parts by mass or more based on 100 parts by mass of a total of the components (A) to (C). On the other hand, from the viewpoint of suppressing the generation of aggregated substances (crosslinked gel), it is typically 1 parts by mass or less, preferably 0.8 part by mass or less, and more preferably 0.6 part by mass or less.

### (E) Silane Coupling Agent:

The component (E) is a silane coupling agent. The silane coupling agent is a silane compound having at least two kind of different reactive groups of a hydrolyzable group (for example, an alkoxy group such as a methoxy group, an ethoxy group and the like; an acyloxy group such as an acetoxy group and the like; a halogen group such as a chloro group and the like) and an organic functional group (for example, an amino group, a vinyl group, an epoxy group, a methacryloxy group, an acryloxy group, an isocyanate group and the like). The component (E) functions to crosslink the component (A) to achieve good compression set. The component (E) is grafted to the component (A), and functions to form a crosslinking point upon aftertreatment with warm water, so-called water-crosslinking treatment.

Examples of the component (E) include a vinyl-based silane coupling agent (a silane compound having a vinyl group and a hydrolyzable group), a methacrylic-based silane coupling agent (a silane compound having a methacryloxy group and a hydrolyzable group), an acrylic-based silane coupling agent (a silane compound having an acryloxy group and a hydrolyzable group), an epoxy-based silane coupling agent (a silane compound having an epoxy group and a hydrolyzable group), an amino-based silane coupling agent (a silane compound having an amino group and a hydrolyzable group), a mercapto-based silane coupling agent (a silane compound having a mercapto group and a hydrolyzable group) and the like. As the component (E), one or more of these can be used. Among these, as the component (E), a vinyl-based silane coupling agent is preferable from the viewpoint of heat distortion resistance.

Examples of the vinyl-based silane coupling agent include vinyltrimethoxysilane, vinyltriethoxysilane, vinyl tris(βmethoxyethoxy) silane, vinyltriacetoxysilane, vinyl-tris(n-butoxy) silane, vinyl-tris(n-pentoxy) silane, vinyl-tris(n-hexoxy) silane, vinyl-tris(n-heptoxy) silane, vinyl-tris(n-octoxy) silane, vinyl-tris(n-dodecyl oxo)silane, vinyl-bis(n-butoxy) methylsilane, vinyl-bis(n-pentoxy) methylsilane, vinyl-bis(n-hexoxy) methylsilane, vinyl-(n-butoxy) dimethylsilane, vinyl-(n-pentoxy) dimethylsilane and the like.

The blending amount of the component (E) is typically 0.5 to 7 parts by mass, preferably 0.8 to 6 parts by mass, and more preferably 1 to 5 parts by mass based on 100 parts by mass of a total of the components (A) to (C). From the viewpoint of sufficiently crosslinking to reduce the compression set, the blending amount of the component (E) is typically 0.5 parts by mass or more, preferably 0.8 parts by mass or more, and more preferably 1 parts by mass or more based on 100 parts by mass of a total of the components (A) to (C). On the other hand, from the viewpoint of the balance (efficiency) of the blending amount and the effect thereof, it may typically be 7 parts by mass or less, preferably 6 parts by mass or less, and more preferably 5 parts by mass or less.

### (F) Crosslinking aid:

The component (F) is a crosslinking aid. The component (F) functions to uniformly and efficiently crosslink the component (D) and the component (E). Therefore, the component (F) is an optional component, but is preferable to be used.

The component (F) is a monomer having two or more polymerizable functional groups in one molecule, and may typically be a polyfunctional vinyl monomer such as divinylbenzene, triallyl cyanurate and the like; a polyfunctional (meth)acrylate monomer such as ethylene glycol di(meth)acrylate, diethylene glycol di(meth)acrylate, triethylene glycol di(meth)acrylate, polyethylene glycol di(meth)acrylate, trimethylolpropane tri(meth)acrylate, allyl (meth)acrylate and the like; and the like. In the present specification, (meth)acrylate means methacrylate or acrylate. As the component (F), one or more of these can be used.

The blending amount of the component (F) is not particularly limited since it is an optional component, but may typically be 0 to 2 parts by mass, preferably 0.05 to 1.5 parts by mass, and more preferably 0.1 to 1 part by mass based on 100 parts by mass of a total of the components (A) to (C). From the viewpoint of obtaining a use effect of the component (F), the blending amount of the component (F) may typically be 0.01 parts by mass or more, preferably 0.05 parts by mass or more, and more preferably 0.1 parts by mass or more. On the other hand, from the viewpoint of controlling the degree of crosslinking to an appropriate range, it may typically be 2 parts by mass or less, preferably 1.5 parts by mass or less, and more preferably 1 part by mass or less.

### (G) Inorganic Filler:

The component (G) is an inorganic filler. The component (G) is an optional component. As the components (A) and (B), those in the form of pellets are generally available commercially. The component (C), the component (D), the component (E) and the component (F) are often liquid at ambient temperature. Therefore, when producing the elastomer composition of the present invention, in order to suppress/prevent separation/non-uniformity between the pellet and the liquid, it is usual that the liquid component is charged into the melt-kneading apparatus by using a liquid adding apparatus, and thus, by using the above component (G), a part or all of the liquid component can be charged into the melt-kneading apparatus together with the pellet form component without using a liquid adding device.

The component (G) is not particularly limited, and any inorganic filler can be used. Examples of the component (G) include calcium carbonate, magnesium carbonate, magnesium oxide, magnesium hydroxide, barium sulfate, talc, mica, clay and the like. Among these, from the viewpoint of the effect of suppressing/preventing the separation/non-uniformity between the pellet form component and the liquid component, calcium carbonate, talc and magnesium hydroxide are preferable. As the component (G), one or more of these can be used.

The blending amount of the component (G) is not particularly limited since it is an optional component, but may typically be 0 to 100 parts by mass, preferably 1 to 90 parts by mass, and more preferably 5 to 80 parts by mass based on 100 parts by mass of a total of the components (A) to (C). From the viewpoint of obtaining a use effect of the component (G), the blending amount of the component (G) may typically be 0.1 parts by mass or more, preferably 1 parts by mass or more, and more preferably 5 parts by mass or more. On the other hand, from the viewpoint of compression set and mechanical strength, it may typically be 100 parts by mass or less, preferably 90 parts by mass or less, and more preferably 80 parts by mass or less.

### (H) Silanol Condensation Catalyst

The component (H) is a silanol condensation catalyst. The component (H) functions to promote and catalyze cross-link (a dehydration condensation reaction between silanols) at a crosslinking point which is formed by grafting the component (E) to the component (A), and to improve (reduce) the compression set upon aftertreatment with warm water, so-called water-crosslinking treatment.

The component (H) is not particularly limited, and any silanol condensation catalyst can be used. Examples of the component (H) include dibutyltin dilaurate, dibutyltin diacetate, dibutyltin dioleate, stannous acetate, lead naphthenate, cobalt naphthenate, zinc caprylate, iron 2-ethylhexanoate, titanate, tetrabutyl titanate, tetranonyl titanate, bis(acetylacetonitrile)diisopropyltitanium/ethylamine complex, hexylamine complex, dibutylamine complex, pyridine complex and the like. As the component (H), one or more of these can be used.

The blending amount of the component (H) is not particularly limited since it is an optional component, but may typically be 0.0001 to 0.3 parts by mass, preferably 0.0005 to 0.2 parts by mass, and more preferably 0.001 to 0.1 parts by mass based on 100 parts by mass of the elastomer composition of the present invention. From the viewpoint of obtaining a use effect of the component (H), the blending amount of the component (H) may typically be 0.0001 parts by mass or more, preferably 0.0005 parts by mass or more, and more preferably 0.001 parts by mass or more. On the other hand, from the viewpoint of the balance (efficiency) of the blending amount and the effect thereof, and the extrudability, it may typically be 0.3 parts by mass or less, preferably 0.2 parts by mass or less, more preferably 0.1 parts by mass or less, and more preferably 0.05 parts by mass or less.

If desired, the elastomer composition of the present invention may further comprise a thermoplastic resin other than the components (A) and (B), a softener other than the component (C), or an additive such as a plasticizer, a pigment, an organic filler, a lubricant, an antioxidant, a thermal stabilizer, a weathering stabilizer, a release agent, an antistatic agent, a metal deactivator, a surfactant and the like, to the extent not contrary to the object of the present invention.

### Production Method:

The elastomer composition of the present invention can be obtained by dynamically heat-treating the components (A) to (E) and components optionally used by using any melt kneader. The “dynamically heat-treating” means melt kneading under the temperature condition where the decomposition of the component (D) organic peroxide occurs significantly. Examples of the melt kneader include a single screw extruder, a twin screw extruder, a roll, a mixer, various kneaders, and an apparatus in which these are combined. The temperature condition for melt kneading may typically be a temperature equal to or higher than the one-minute half-life temperature of the component (D), preferably a temperature 5° C. higher than the one-minute half-life temperature of the component (D). The time condition for melt kneading may typically be 30 seconds or more, preferably 2 minutes or more.

The water-crosslinkable elastomer composition of the present invention can be obtained by blending the component (H) to the elastomer composition of the present invention. As the component (H), a silanol condensation catalyst may be blended by itself, or it may be blended as a composition melt kneaded with an optional resin, so-called master batch. From the viewpoint of handling property, it is preferable to blend the component (H) as a master batch. The optional resin used for the master batch is not particularly limited, but an ethylene/α-olefin copolymer, a propylene-based resin and the like are preferable from the viewpoint of miscibility with the elastomer composition of the present invention. If desired, the master batch can further comprise a softener, a plasticizer, a pigment, an organic filler, a lubricant, an antioxidant, a thermal stabilizer, a weathering stabilizer, a release agent, a antistatic agent, a metal deactivator, a surfactant and the like to the extent not contrary to the object of the present invention.

The molded article of the present invention can be obtained by molding the water-crosslinkable elastomer composition of the present invention into an optional shape by using an optional forming machine, and then subjecting it to aftertreatment with warm water, a so-called water-crosslinking treatment. The temperature condition for the water-crosslinking treatment may typically be ambient temperature (20° C.) to 150° C., and preferably 50 to 90° C. The time condition for the water-crosslinking treatment may typically be 10 seconds to 1 week, and preferably 1 minute to 3 days. It can also be brought into contact with water under pressure. Further, in order to improve the wetting of the molded article, the water may comprise a wetting agent or a surfactant, a water-soluble organic solvent and other additives. Water is not limited to liquid water, and may be in a state such as a gas (water vapor or moisture in air). Examples of the forming machine include an extrusion molding machine, an injection molding machine, a blow molding machine and the like.

### EXAMPLES

Hereinafter, the present invention will be explained by way of Examples, but is not limited thereto.

### Raw Material Used

### (A) Ethylene/α-Olefin Copolymer:

(A-1) Ethylene/1-octene copolymer rubber “Engage 8180 (trade name)” from Dow Chemical Co. Ltd., Content of structural unit derived from ethylene 72% by mass, Melt Mass Flow Rate (Temperature 190° C., Load 21.18N) 0.5 g/10 min, Density 863 Kg/m³.

(A-2) Ethylene/propylene/ethylidene norbornene copolymer rubber (EPDM) “NORDEL IP4760P (trade name)” from Dow Chemical Co. Ltd., Content of structural unit derived from ethylene 67% by mass, Mooney viscosity ML₁₊₄ (125° C.) 70, Density 880 kg/m³.

### (B) Propylene-Based Resin:

(B-1) Propylene/ethylene block copolymer “VB370A (trade name)” from SunAllomer Co. Ltd., Melting point 160° C., Melt Mass Flow Rate (Temperature 230° C., Load 21.18N) 1.5 g/10 min.

### (C) Non-Aromatic Softener for Rubber:

(C-1) Paraffinic mineral oil “Dyna process oil PW90 (product name)” from Idemitsu Kosan Co., Ltd., Dynamic viscosity 95.5 cSt (40° C.), Flow point −15° C., Flash point 272° C.

(C-2) Paraffinic mineral oil “Dyna process oil PW100 (trade name)” from Idemitsu Kosan Co., Ltd.

### (D) Organic Peroxide:

(D-1) 2,5-dimethyl-2,5-di-(t-butylperoxy)hexane from NOF corporation, “Perhexa 25B (trade name).” One-minute half-life temperature 179.8° C.

### (E) Silane Coupling Agent:

(E-1) Vinyltrimethoxysilane “KBM-1003 (trade name)” from Shin-Etsu Chemical Co., Ltd.

### (F) Crosslinking Aid:

(F-1) Divinylbenzene “DVB-570 (trade name)” from Nippon Steel & Sumitomo Metal corporation.

### (G) Inorganic Filler:

(G-1) Calcium carbonate “NS400 (trade name)” from NITTO FUNKA KOGYO K.K.

### (H) Silanol Condensation Catalyst:

(H-1) Dioctyltin dilaurate “NEOSTAN U-810 (trade name)” from NITTO KASEI Co., Ltd.

### (J) Optional Components:

(J-1) Hindered phenolic antioxidant “IRGANOX1010 (trade name)” from BASF.

(J-2) Phosphorus antioxidant “IRGAFOS168 (trade name)” from BASF.

### Example 1

### (1) Production of Elastomer Composition:

An elastomer composition was produced by using 0.2 parts by mass of the component (D-1), 2 parts by mass of the component (E-1), 0.2 parts by mass of the component (F-1), 16 parts by mass of the component (G-1), 0.1 parts by mass of the component (J-1) and 0.05 parts by mass of the component (J-2) based on 100 parts by mass of a composition consisting of 100 parts by mass of the component (A-1), 50 parts by mass of the component (B-1) and 50 parts by mass of the component (C-1). The elastomer composition was obtained by feeding the components other than the component (C-1) with a co-rotation twin screw extruder to position of a base of a screw of the extruder after dry blending by using a blender, feeding the component (C-1) with a liquid adding device to intermediate position of the extruder, and melt kneading these components under condition of 200° C. of resin temperature at a dice outlet.

### (2) Production of Silanol Catalyst Master Batch:

A silanol catalyst master batch was produced by using 0.17 parts by mass of the component (D-1), 0.34 parts by mass of the component (F-1), 16 parts by mass of the component (G-1), 1 parts by mass of (H-1), 0.1 parts by mass of the component (J-1) and 0.05 parts by mass of the component (J-2) based on 100 parts by mass of a composition consisting of 100 parts by mass of the component (A-2), 50 parts by mass of the component (B-1) and 50 parts by mass of the component (C-1). The silanol catalyst master batch was obtained by feeding the components other than the component (C-1) with a co-rotation twin screw extruder to position of a base of a screw of the extruder after dry blending by using a blender, feeding the component (C-1) with a liquid adding device to intermediate position of the extruder, and melt kneading these components under condition of 200° C. of resin temperature at a dice outlet.

### (3) Production of Water-Crosslinkable Elastomer Composition:

A water-crosslinkable elastomer composition was obtained by dry blending 100 parts by mass of the elastomer composition obtained in the above step (1) and 5 parts by mass of the silanol catalyst master batch obtained in the above step (2) (0.043 parts by mass in terms of the component (H-1)) with a blender.

### (4) Production of Molded Article:

Using the water-crosslinkable elastomer composition obtained in the above step (3), a flat plate having thickness of 2 mm, length of 130 mm and width of 130 mm was produced under condition of 200° C. of injection resin temperature with an injection molding machine.

### (4-1) Molded Article for Collecting a Tensile Test Piece:

The flat plate obtained above was immersed in warm water at a temperature of 80° C. for 48 hours to obtain a molded article for collecting a tensile test piece.

### (4-2) Molded Article for Collecting Test Piece for Compression Set or Hardness:

Four flat plates obtained above were laminated and pressed at a temperature of 200° C. to obtain a flat plate having thickness of 6.3 mm, length of 160 mm, width of 130 mm, and then the obtained flat plate was immersed in warm water at a temperature of 80° C. for 48 hours to obtain a molded article for collecting test piece for compression set or hardness.

The following tests (1) to (3) were carried out. The results are shown in Table 1.

In the Table, the blending amounts of the components (A) to (C) are based on 100 parts by mass of the component (A).

In the Table, composition P means a composition consisting of the above components (A) to (C).

In the Table, the blending amounts of the components (D) to (G) and the component (J) are values based on 100 parts by mass of the composition P (the composition consisting of the components (A) to (C)). In the Table, composition Q means an elastomer composition.

In the Table, composition R means a water-crosslinkable elastomer composition.

In the Table, MB means a silanol catalyst master batch.

In the Table, the blending amount of MB is a value based on 100 parts by mass of the elastomer composition. In this case, it was calculated so that the components of MB other than the component (H) are not included in the elastomer composition.

In the Table, the value of the component (H) is the blending amount of the component (H) calculated from the blending amount of MB based on 100 parts by mass of the elastomer composition. In this case, “H-1” column was calculated so that the components of MB other than the component (H) are not included in the elastomer composition, and “H-1 converted” column was calculated so that the components of MB other than the component (H) are included in the elastomer composition.

### (1) Hardness:

According to JIS K6253-3: 2012, the hardness of Shore A (instantaneous value) was measured using the molded article obtained in the above (4-2).

### (2) Compression Set:

According to JIS K6262: 2013, the compression set was measured using the molded article obtained in the above (4-2) under the conditions of compression rate 25%, a small test piece, temperature of 70° C., 120° C. or 150° C., 22 hours and method A.

### (3) Tensile Test:

According to JIS K6251: 2010, measurement was carried out using a dumbbell-shaped No. 3 test piece punched out from the molded article obtained in the above (4-1) under the condition of a tensile speed of 500 mm/min.

### Examples 2 to 21

The same procedures as Example 1 were carried out except that the components of the elastomer composition were changed as shown in any one of Tables 1 to 4. The results are shown in any of Tables 1 to 4.

In Example 13, since a large amount of crosslinked gel was generated and pelletizing could not be performed, the evaluation of physical properties was omitted. In Example 15, since the strands were flaky and pelletizing could not be performed, the evaluation of physical properties was omitted. In Example 16, the bleed-out of the component

(C-1) was extremely generated, and thus it was difficult to use. In Example 18, since a large amount of crosslinked gel was generated and pelletizing could not be performed, the evaluation of physical properties was omitted. In Example 20, since a large amount of crosslinked gel was generated and pelletizing could not be performed, the evaluation of physical properties was omitted. In Example 21, since the remarkable discharge fluctuation occurred in the production of the elastomer composition in the above step (1), and stable production could not be performed, the evaluation of physical properties was omitted.

### Example 22

(1′) An elastomer composition was produced by using 0.17 parts by mass of the component (D-1), 0.34 parts by mass of the component (F-1), 0.1 parts by mass of the component (J-1) and 0.05 parts by mass of the component (J-2) based on 100 parts by mass of the composition consisting of 100 parts by mass of the component (A-2), 56 parts by mass of the component (B-1) and 67 parts by mass of the component (C-1). The elastomer composition was obtained by feeding the components other than the components (C-1) with a co-rotation twin screw extruder to position of a base of the extruder after dry blending by using a blender, feeding the component (C-1) with a liquid adding device to intermediate position of the extruder, and melt kneading these components under condition of 200° C. of resin temperature at a dice outlet.
(2′) Using the elastomer composition obtained in the above step (1′), a flat plate having thickness of 2 mm, length of 130 mm and width of 130 mm was produced under condition of 200° C. of injection resin temperature with an injection molding machine.
(3′) Further, four flat plates obtained in the above (2′) were laminated and pressed at a temperature of 200° C. to obtain a flat plate for test piece for compression set or hardness having thickness of 6.3 mm, length of 160 mm and width of 130 mm.

The above tests (1) to (3) were carried out. The results are shown in Table 4.

### Example 23

Table 4 shows the results obtained in the same manner as in Example 22 except that an olefinic thermoplastic elastomer composition “SANTPLAIN101-73 (trade name)” from AES was used as the elastomer composition.

### Example 24

Table 4 shows the results obtained in the same manner as in Example 22 except that an olefinic thermoplastic elastomer composition “SANTPLAIN101-87 (trade name)” from AES was used as the elastomer composition.

TABLE 1

| | | Ex. 1 | Ex. 2 | Ex. 3 | Ex. 4 | Ex. 5 | Ex. 6 |
|---|---|---|---|---|---|---|---|
| Composition P | A-1 | 100 | | | 43 | | |
| | A-2 | | 100 | 100 | 57 | 100 | 100 |
| | B-1 | 50 | 50 | 37 | 39 | 31 | 22 |
| | C-1 | 50 | 50 | 67 | 78 | 73 | 75 |
| Composition Q | Composition P | 100 | 100 | 100 | 100 | 100 | 100 |
| | D-1 | 0.2 | 0.2 | 0.2 | 0.3 | 0.15 | 0.15 |
| | E-1 | 2 | 2 | 2 | 4 | 2 | 2 |
| | F-1 | 0.15 | 0.15 | 0.1 | 0.1 | 0.1 | |
| | G-1 | 16 | 16 | 16 | 16 | 16 | 16 |
| Composition R | Composition Q | 100 | 100 | 100 | 100 | 100 | 100 |
| | MB | 5 | 5 | 5 | 5 | 5 | 5 |
| | H-1 | 0.043 | 0.043 | 0.043 | 0.043 | 0.043 | 0.043 |
| | H-1 converted | 0.043 | 0.043 | 0.043 | 0.043 | 0.043 | 0.043 |
| Evaluation results | Hardness | 78 | 76 | 69 | 68 | 61 | 55 |
| | Compression | 21 | 23 | 17 | 14 | 18 | 13 |
| | set, 70° C. % | | | | | | |
| | Compression | 33 | 32 | 23 | 23 | 22 | 15 |
| | set, 120° C. % | | | | | | |
| | Compression | 48 | 43 | 31 | 36 | 28 | 19 |
| | set, 150° C. % | | | | | | |
| | Tensile strength | 10.0 | 7.8 | 6.0 | 6.9 | 5.5 | 4.9 |
| | MPa | | | | | | |
| | Tensile | 350 | 370 | 320 | 240 | 360 | 320 |
| | elongation % | | | | | | |

TABLE 2

| | | Ex. 7 | Ex. 8 | Ex. 9 | Ex. 10 | Ex. 11 | Ex. 12 |
|---|---|---|---|---|---|---|---|
| Composition P | A-1 | | 100 | | 100 | 100 | |
| | A-2 | 100 | | 100 | | | 100 |
| | B-1 | 15 | 50 | 120 | 66 | 25 | 50 |
| | C-1 | 77 | 50 | 100 | 120 | 25 | 50 |
| Composition Q | Composition P | 100 | 100 | 100 | 100 | 100 | 100 |
| | D-1 | 0.1 | 0.2 | 0.2 | 0.2 | 0.2 | 0.2 |
| | E-1 | 2 | 0.75 | 3 | 3 | 2 | 2 |
| | F-1 | | 0.15 | 0.1 | 0.1 | 0.1 | 0.1 |
| | G-1 | 16 | | 16 | 16 | 16 | 85 |
| Composition R | Composition Q | 100 | 100 | 100 | 100 | 100 | 100 |
| | MB | 5 | 5 | 5 | 5 | 5 | 5 |
| | H-1 | 0.043 | 0.043 | 0.043 | 0.043 | 0.043 | 0.043 |
| | H-1 converted | 0.043 | 0.043 | 0.043 | 0.043 | 0.043 | 0.043 |
| Evaluation results | Hardness | 47 | 80 | 92 | 79 | 75 | 79 |
| | Compression | 13 | 25 | 35 | 27 | 14 | 23 |
| | set, 70° C. % | | | | | | |
| | Compression | 15 | 37 | 50 | 40 | 19 | 34 |
| | set, 120° C. % | | | | | | |
| | Compression | 17 | 50 | 65 | 55 | 25 | 44 |
| | set, 150° C. % | | | | | | |
| | Tensile strength | 3.9 | 9.0 | 15.0 | 7.3 | 8.2 | 7.0 |
| | MPa | | | | | | |
| | Tensile | 380 | 440 | 330 | 300 | 260 | 350 |
| | elongation % | | | | | | |

TABLE 3

| | | Ex. 13 | Ex. 14 | Ex. 15 | Ex. 16 | Ex. 17 | Ex. 18 |
|---|---|---|---|---|---|---|---|
| Composition P | A-1 | | | | | | |
| | A-2 | 100 | 100 | 100 | 100 | 100 | 100 |
| | B-1 | 8 | 160 | 30 | 50 | 50 | 50 |
| | C-1 | 80 | 75 | 3 | 160 | 50 | 50 |
| Composition Q | Composition P | 100 | 100 | 100 | 100 | 100 | 100 |
| | D-1 | 0.2 | 0.2 | 0.2 | 0.2 | | 1.5 |
| | E-1 | 2 | 2 | 2 | 2 | 2 | 2 |
| | F-1 | 0.1 | 0.1 | 0.1 | 0.1 | 0.1 | 0.1 |
| | G-1 | 16 | 16 | 16 | 16 | 16 | 16 |
| Composition R | Composition Q | 100 | 100 | 100 | 100 | 100 | 100 |
| | MB | 5 | 5 | 5 | 5 | 5 | 5 |
| | H-1 | 0.043 | 0.043 | 0.043 | 0.043 | 0.043 | 0.043 |
| | H-1 converted | 0.043 | 0.043 | 0.043 | 0.043 | 0.043 | 0.043 |
| Evaluation results | Hardness | — | ≥95 | — | 60 | 70 | — |
| | Compression | — | 50 | — | 25 | 98 | — |
| | set, 70° C. % | | | | | | |
| | Compression | — | 72 | — | 38 | 100 | — |
| | set, 120° C. % | | | | | | |
| | Compression | — | 92 | — | 50 | 100 | — |
| | set, 150° C. % | | | | | | |
| | Tensile strength | — | 18.0 | — | 4.4 | 5.5 | — |
| | MPa | | | | | | |
| | Tensile | — | 420 | — | 330 | 900 | — |
| | elongation % | | | | | | |

TABLE 4

| | | Ex. 19 | Ex. 20 | Ex. 21 | Ex. 22 | Ex. 23 | Ex. 24 |
|---|---|---|---|---|---|---|---|
| Composition P | A-1 | | | | | | |
| | A-2 | 100 | 100 | 100 | 100 | | |
| | B-1 | 50 | 50 | 50 | 56 | | |
| | C-1 | 50 | 50 | 50 | 67 | | |
| Composition Q | Composition P | 100 | 100 | 100 | 100 | | |
| | D-1 | 0.2 | 0.2 | 0.2 | 0.17 | | |
| | E-1 | 0 | 2 | 2 | | | |
| | F-1 | 0.1 | 3 | 0.1 | 0.34 | | |
| | G-1 | 16 | 16 | 120 | | | |
| Composition R | Composition Q | 100 | 100 | 100 | | | |
| | MB | 5 | 5 | 5 | | | |
| | H-1 | 0.043 | 0.043 | 0.043 | | | |
| | H-1 converted | 0.043 | 0.043 | 0.043 | | | |
| Evaluation results | Hardness | 72 | — | — | 76 | 79 | 93 |
| | Compression | 34 | — | — | 42 | 30 | 50 |
| | set, 70° C. % | | | | | | |
| | Compression | 45 | — | — | 46 | 45 | 61 |
| | set, 120° C. % | | | | | | |
| | Compression | 64 | — | — | 65 | 64 | 81 |
| | set, 150° C. % | | | | | | |
| | Tensile strength | 5.8 | — | — | 7.0 | 7.5 | 15 |
| | MPa | | | | | | |
| | Tensile | 480 | — | — | 420 | 450 | 530 |
| | elongation % | | | | | | |

### Example 25

### (1) Production of Elastomer Composition:

An elastomer composition was produced by using 0.26 parts by mass of the component (D-1), 1.5 parts by mass of the component (E-1), 0.22 parts by mass of the component (F-1), 16 parts by mass of the component (G-1), 0.11 parts by mass of the component (J-1) and 0.11 parts by mass of the component (J-2) based on 100 parts by mass of a composition consisting of 100 parts by mass of the component (A-2), 61 parts by mass of the component (B-1) and 54 parts by mass of the component (C-2). The elastomer composition was obtained by feeding the components other than the component (C-1) with a co-rotation twin screw extruder to position of a base of a screw of the extruder after dry blending by using a blender, feeding the component (C-1) with a liquid adding device to intermediate position of the extruder, and melt kneading these components under condition of 200° C. of resin temperature at a dice outlet.

### (2) Production of Silanol Catalyst Master Batch:

A silanol catalyst master batch was produced by mixing and stirring 96.6 parts by mass of the component (C-2) and 0.4 parts by mass of the component (H-1).

### (3) Production of Water-Crosslinkable Elastomer Composition:

A water-crosslinkable elastomer composition was obtained by dry blending 100 parts by mass of the elastomer composition obtained in the above step (1) and 0.5 parts by mass of the silanol catalyst master batch obtained in the above step (2) (0.002 parts by mass in terms of the component (H-1)) with a blender.

### (4) Production of Molded Article:

Using the water-crosslinkable elastomer composition obtained in the above step (3), a flat plate having thickness of 2 mm, length of 130 mm and width of 130 mm was produced under condition of 200° C. of injection resin temperature with an injection molding machine.

### (4-1) Molded Article for Collecting Tensile Test Piece:

The flat plate obtained above was immersed in warm water at a temperature of 80° C. for 48 hours to obtain a molded article for collecting a tensile test piece.

### (4-2) Molded Article for Collecting Test Piece for Compression Set or Hardness:

Four flat plates obtained above were laminated and pressed at a temperature of 200° C. to obtain a flat plate having thickness of 6.3 mm, length of 160 mm, width 130 mm, and then the obtained flat plate was immersed in warm water at a temperature of 80° C. for 48 hours to obtain a molded article for collecting test piece for compression set or hardness.

The following tests (1) to (5) were carried out. The results are shown in Table 5.

Also, the water-crosslinkable elastomer composition obtained in the above step (3) was extruded by using a 40 mm single screw extruder and a flat plate type of metallic mold having thickness of 1 mm under conditions of metallic mold outlet resin temperature of 230° C. and a screw rotation frequency of 40 rpm, and the obtained wound body of sheet was then immersed in warm water at a temperature of 80° C. for 48 hours to obtain an extruded sheet. As a result, the extruded sheet having a smooth surface without a defect such as aggregated substances or gels could be obtained

### (1) Hardness:

According to JIS K6253-3: 2012, the hardness of Shore A (instantaneous value) was measured using the molded article obtained in the above (4-2).

### (2) Compression Set:

According to JIS K6262: 2013, the compression set was measured using the molded article obtained in the above (4-2) under the conditions of compression ratio of 25%, a small test piece, temperature of 70° C., 100° C. or 120° C., 22 hours and method A.

Similarly, the compression set was measured under the conditions of compression ratio of 25%, a small specimen, temperature of 70° C., 22 hours and method B.

### (3) Bending Permanent Strain:

According to JIS K6262: 2013, the compression set at the time of bending (bending permanent strain) was measured by fixing and holding the molded article obtained in the above (4-2) in a state bent at 90 degrees using a metallic jig under the conditions of compression rate 25%, temperature of 100° C., 22 hours and the method A.

### (4) Tensile Permanent Strain:

According to JIS K6273: 2006 except that the test time was 22 hours, the tensile permanent strain was measured using a dumbbell-shaped No. 3 test piece punched out from the molded article obtained in the above (4-1) under the conditions of temperature 70° C., elongation to be applied to the test piece 20%, speed to apply elongation 5 mm/sec and method A or method B.

### (5) Tensile Test:

According to JIS K6251: 2010, measurement was carried out using a dumbbell-shaped No. 3 test piece punched out from the molded article obtained in the above (4-1) under the condition of a tensile speed of 500 mm/min.

TABLE 5

| | | Ex. 25 |
|---|---|---|
| Composition P | A-1 | |
| | A-2 | 100 |
| | B-1 | 61 |
| | C-1 | |
| | C-2 | 54 |
| Composition Q | Composition P | 100 |
| | D-1 | 0.26 |
| | E-1 | 1.5 |
| | F-1 | 0.22 |
| | G-1 | 16 |
| | J-1 | 0.11 |
| | J-2 | 0.11 |
| Composition R | Composition Q | 100 |
| | MB | 0.5 |
| | H-1 | 0.002 |
| | H-1 converted | 0.002 |
| Evaluation results | Hardness | 79 |
| | Compression set, | 35 |
| | A method, 70° C. % | |
| | Compression set, | 64 |
| | B method, 70° C. % | |
| | Compression set, | 54 |
| | A method, 100° C. % | |
| | Compression set, | 59 |
| | A method, 120° C. % | |
| | Bending permanent strain % | 32 |
| | Tensile permanent strain, A method | 8 |
| | Tensile permanent strain, B method | 13 |
| | Tensile strength MPa | 6.8 |
| | Tensile elongation % | 600 |

The elastomer composition of the present invention can be molded like a thermoplastic resin by using a conventional plastics processing equipment, and has a very small compression set like a vulcanized rubber. Therefore, it can be suitably used for packing for automobile, packing for building materials and the like as a substitutive material for vulcanized rubber.

1. An elastomer composition comprising:
100 parts by mass of an ethylene/α-olefin copolymer (A);
10 to 150 parts by mass of a propylene-based resin (B); and
5 to 150 parts by mass of a non-aromatic softener for rubber (C);
0.03 to 1 parts by mass of an organic peroxide (D);
0.5 to 7 parts by mass of a silane coupling agent (E);
0 to 2 parts by mass of a crosslinking aid (F); and
0 to 100 parts by mass of an inorganic filler (G);
wherein each amount of (D) to (G) is based on 100 parts by mass of a composition consisting of the ethylene/α-olefin copolymer (A), the propylene-based resin (B) and the non-aromatic softener for rubber (C).

2. A water-crosslinkable elastomer composition further comprising 0.0001 to 0.3 parts by mass of a silanol condensation catalyst (H) based on 100 parts by mass of the elastomer composition according to claim 1.

3. A molded article comprising the elastomer composition according to claim 1.

4. A method for producing a molded article comprising:
(1) a step of dynamically heat-treating an elastomer composition comprising
100 parts by mass of an ethylene/α-olefin copolymer (A);
10 to 150 parts by mass of a propylene-based resin (B); and
5 to 150 parts by mass of a non-aromatic softener for rubber (C);
0.03 to 1 parts by mass of (D) an organic peroxide;
0.5 to 7 parts by mass of (E) a silane coupling agent;
0 to 2 parts by mass of (F) a crosslinking aid; and
0 to 100 parts by mass of (G) an inorganic filler;
wherein each amount of (D) to (G) is based on 100 parts by mass of a composition consisting of the ethylene/α-olefin copolymer (A), the propylene-based resin (B) and the non-aromatic softener for rubber (C);
(2) a step of blending 0.0001 to 0.3 parts by mass of a silanol condensation catalyst (H) to 100 parts by mass of the elastomer composition which is dynamically heat-treated in the step (1);
(3) a step of forming the elastomer composition to which the silanol condensation catalyst (H) is blended in the step (2) into a molded article by using a forming machine; and
(4) a step of treating the molded article formed in the step (3) with warm water.

5. A molded article comprising the water-crosslinkable elastomer composition according to claim 2.
